(19) United States
(12) Patent Application Publication
(10) Pub. No.: US 2013/0220375 A1
(43) Pub. Date: Aug. 29, 2013

(54) PH MONITORING DEVICE

(71) Applicants: Jun Shi, Eindhoven (NL); Weiran Wang, Eindhoven (NL)

(72) Inventors: Jun Shi, Eindhoven (NL); Weiran Wang, Eindhoven (NL)

(73) Assignee: KONINKLIJKE PHILIPS ELECTRONICS N.V., EINDHOVEN (NL)

(21) Appl. No.: 13/881,578

(22) PCT Filed: Nov. 10, 2011
(86) PCT No.: PCT/IB11/55007

§ 371 Date: Apr. 25, 2013

(30) Foreign Application Priority Data
Nov. 10, 2010 (CN) PCT/CN2010/078600

(51) Int. Cl. G01N 31/00

(52) U.S. Cl. CPC G01N 31/00
USPC 134/18; 422/82.03; 436/2; 204/228.6; 205/743; 134/115 R

(57) ABSTRACT

The invention proposes a pH monitoring device 10 comprising a chamber 107 for containing a solution; a polymer 105 being immersed in the solution, wherein the physical state of the polymer is changeable in dependence on whether the pH of the solution exceeds a threshold value; and a detector 109 for detecting the change of the physical state of the polymer.

### FIELD OF THE INVENTION

The present invention relates to a method and a device for monitoring the pH value of a solution. It further relates to monitoring the pH value of electrolyzed water.

### BACKGROUND OF THE INVENTION

Electrolyzed water, i.e. alkaline water and acid water can be used in many fields. For example, slightly alkaline water can be used for drinking because people believe that drinking slightly alkaline water is beneficial to health. Alkaline water is also proposed to be used for cleaning food (fruits and/or vegetables) because alkaline water can help remove pesticide residue from vegetables and fruit. For another example, acid water is used for sterilization (killing bacteria). In these various applications, the pH (hydrogen ion concentration) of the alkaline water or acid water needs to be controlled for safety purposes or for better effect. For example, when using alkaline water to clean food, the alkaline water is electrolyzed tap water and flows to the sink for use by the user; as the safe pH value for long time skin contact is suggested to be below 10.5, the pH values should be monitored and controlled.

A traditional pH meter uses two glass electrodes: the indicator electrode and the reference electrode. When the two electrodes are immersed in a solution, a small galvanic cell is established. The potential developed is dependent on both electrodes. The response is caused by an exchange at both surfaces of the swollen membrane between the ions of the glass and the H+ of the solution in an ion exchange which is controlled by the concentration of H+ in both solutions. This traditional pH-sensing technology could be miniaturized to a certain size to measure pH values in vivo and report data telemetrically.

Another pH-sensing technology is based on the use of an ion-sensitive field effect transistor (ISFET). In an ISFET, a H+-sensitive buffer coating is applied to the gate electrode.

Therefore, the voltage drop between the drain and source electrodes becomes a function of H+ concentration to which the gate electrode is exposed. An ISFET-based pH-sensor can be built into a small volume. Laboratory ISFET pH-sensors are commercially available and are generally more expensive than traditional glass-electrode pH-sensors.

Both traditional and ISFET-based pH sensors require calibration and a reference electrode, making their use complicated. Current ISFET cost is relatively high. WO 2008/135930 describes a biochemical sensing device for measuring an analyte level. The process includes providing an electrode coated with a compound/polymer, wherein the compound/polymer has an analyte-dependent solubility profile, exposing the compound/polymer coated electrode to the solution, measuring the conductance at the electrode as a function of time, and correlating the conductance with the solubility of the compound/polymer to determine the pH of the solution. In this application, the property of solubility of the polymer is used to determine the pH value of the solution.

However, sometimes there is an application which does not require measuring the absolute pH value of a solution, as a result of which a simple and cheap solution is sufficient to control the pH value of the solution to make sure that the pH value of the solution does not exceed a threshold value.

### OBJECT AND SUMMARY OF THE INVENTION

To address the above mentioned one or more problems, this invention provides a pH monitoring device comprising:
a chamber for containing a solution;
a polymer being immersed in the solution, wherein the physical state of the polymer is changeable in dependence on whether the pH of the solution exceeds a threshold value;
a detector for detecting the change of the physical state of the polymer.

With this device, when the detector detects the change of the physical state of the polymer, it means that the pH value of the solution has exceeded a threshold value.

According to the different property of the polymer used, the detector can be realized in different ways.

Advantageously, when the change of the physical state of the polymer corresponds to the polymer being dissolved by the solution, the detector comprises:
a light source for emitting a light beam;
an optical sensor for detecting the light beam;
wherein the polymer is positioned between the light source and the light beam such that the light beam is blocked by the polymer and the light beam can be detected by the optical sensor when the polymer is dissolved.

Advantageously, when the change of the physical state of the polymer corresponds to the polymer being caused to swell by the solution, the detector comprises:
a light source for emitting a light beam;
an optical sensor for detecting the light beam;
wherein the polymer is positioned between the light source and the light beam such that when the polymer is caused to swell, the light beam is blocked by the swollen polymer.

Advantageously, when the change of the physical state of the polymer corresponds to the polymer being dissolved by the solution, the detector comprises:
two electrodes insulated by the polymer, and when the polymer is dissolved, the two electrodes can be electrically connected by the solution;
a power source connected with the two electrodes;
an electrical sensor for detecting whether the two electrodes are electrically connected or not.

Advantageously, when the change of the physical state of the polymer corresponds to the polymer being dissolved by the solution, and the polymer is positioned in the chamber such that the flow of the solution is blocked by the polymer and the flow of the solution can be detected when the polymer is dissolved, said detector comprises a flow sensor for detecting the flow rate of the solution.

Advantageously, when the change of the physical state of the polymer corresponds to the polymer being caused to swell by the solution, and the polymer is positioned in the chamber such that the flow of the solution is blocked when the polymer is swollen, said detector comprises a flow sensor for detecting the flow rate of the solution.
Using the above described pH monitoring device, the present invention further proposes a device for processing. The device comprises:
a pH monitoring device as mentioned above;
an electrolysis unit for electrolyzing water to obtain alkaline water and acid water, wherein the alkaline water or the acid water corresponds to the solution;
a controller for stopping the electrolyzing of water when the change of the physical state of the polymer has been detected.

In this way, the water-electrolyzing process can be controlled so that the pH of the alkaline water or acid water will not go beyond the predefined threshold.

According to one embodiment of this invention, a system for cleaning food using the aforementioned device for processing water to obtain alkaline water is disclosed. The obtained alkaline water is used for cleaning food.

According to another aspect of the present invention, there is provided a method of monitoring the pH of a solution. The method comprises the steps of:
immersing a polymer in the solution, wherein the physical state of the polymer is changeable in dependence on whether the pH of the solution exceeds a threshold value;
detecting the change of the physical state of the polymer by a detector.

Based on the property of the polymer, the step of detecting the change of the physical state of the polymer can be realized in different ways.

Advantageously, when the detector comprises a light source for emitting a light beam, and the polymer is positioned between the light source and the light beam; the step of detecting the change of the physical state comprises a step of detecting the light beam by an optical sensor.

Advantageously, when the detector comprises two electrodes insulated by the polymer, and the two electrodes can be electrically connected by the solution when the polymer is dissolved; and a power source connected with the two electrodes, the step of detecting the change of the physical state comprises a step of detecting whether the two electrodes are electrically connected or not by an electrical sensor.

Advantageously, the polymer is positioned in the chamber such that the flow of the solution is blocked when the polymer is swollen, or the polymer is positioned in the chamber such that the flow of the solution is blocked by the polymer and the flow of the solution can be detected when the polymer is dissolved; the step of detecting the change of the physical state comprises a step of detecting the flow rate of the solution.

The present invention also proposes a method of processing water, the method comprising the steps of:
electrolyzing water to obtain alkaline water and acid water;
monitoring the pH of the alkaline water or the acid water according to the pH monitoring method as described above;
stopping the water-electrolyzing step when the change of the physical state of the polymer has been detected.

The present invention also proposes a method of cleaning food, the method comprising the steps of:
processing water according to the method as claimed in claim 14 so as to obtain the alkaline water and the acid water;
washing food by using the electrolyzed alkaline water.

### BRIEF DESCRIPTION OF THE DRAWINGS

The invention is explained in further detail, and by way of example, with reference to the accompanying drawings, in which:

FIG. 1 shows a pH monitoring device for monitoring the pH of the solution according to an embodiment of the invention;

FIG. 2 shows another example of a pH monitoring device;

FIG. 3 shows another example of a pH monitoring device;

FIG. 4 shows an example of a device 40 for processing water;

FIG. 5 shows a flow chart of monitoring the pH of a solution according to an embodiment of the invention;

FIG. 6 shows a flow chart of processing water according to an embodiment of the invention;

FIG. 7 shows an example of polymerization of ethane into polyethene;

FIG. 8 shows the structure of HPMC (Hypromellose cellulose).

The dotted lines in the Figures indicate related steps or blocks that are optional; in some embodiments, these can be omitted.

Throughout the above drawings, like reference numerals will be understood to refer to like, similar or corresponding features or functions.

### DETAILED DESCRIPTION

A polymer in the context of the present invention is a long, repeating chain of atoms, formed through the linkage of many molecules called monomers. The monomers can be identical, or they can have one or more substituted chemical groups. These differences between monomers can affect properties such as solubility, flexibility, or strength. A key feature that distinguishes polymers from other large molecules is the repetition of units of atoms (monomers) in their chains. This occurs during polymerization, in which many monomer molecules link to each other.

FIG. 7 shows an example of polymerization of ethane to polyethene. The formation of polyethene involves thousands of ethene molecules bonding together to form a chain of repeating —CH2— units. The —CH2-units are the monomer units of polyethene.

In the present invention, a pH-sensitive polymer is needed which has the characteristics that when the polymer is immersed in the solution, the physical state of such a pH-sensitive polymer can be changed when the pH of the solution exceeds a threshold value. The change of the physical state of the polymer corresponds to the polymer being dissolved by the solution when the pH of an alkali solution is higher than a threshold value or when the pH of an acidic solution is lower than a threshold value. The change of the physical state of the polymer could also correspond to the polymer being caused to swell by the solution when the pH of an alkali solution is higher than a threshold value or when the pH of an acidic solution is lower than a threshold value. In this respect, the change of the physical state of the polymer could also be understood as the change of the dimension of the polymer. When the polymer is being dissolved, the dimension becomes smaller and smaller until the polymer is finally totally dissolved in the solution. When the polymer is caused to swell, the dimension becomes bigger and bigger.

The pH-sensitive polymers are materials which respond to changes in the pH of the surrounding medium by varying their dimensions. Such materials either swell or collapse, depending on the pH of their environment. They demonstrate this behavior due to the presence of certain functional groups in the polymer chain.

An example of such a pH-sensitive polymer is the polymer having acidic group (—COOH, —SO3H) which will swell in basic pH, e.g. polyacrylic acid. Another kind of polymer is one having basic groups (—NH2) which will swell in acidic pH, e.g. cellulose. The mechanism of response is the same for both examples, just the stimuli vary. These materials are being extensively used in controlled drug delivery systems and biomimetics. FIG. 8 is the structure of HPMC (Hypromellose cellulose), whose basic resin is cellulose. The property of a polymer that is sensitive to the pH value of the solution is triggered due to the presence of ionisable functional groups (like —COOH,) which get ionized and acquire a charge (+/−) at a certain pH. The polymer chains now have many similarly charged groups which cause repulsion and hence the material expands in dimensions. The opposite happens when pH changes and the functional groups lose their charge, hence the repulsion is gone and the material collapses back.

An example of a polymer which will change its physical state dramatically when the pH value exceeds 11 is described in “Synthesis of pH-sensitive modified cellulose ether halfesters and their use in pH detecting systems based on fiber optics”, Journal of Controlled Release, 1995, (35) 155-163, which are incorporated herein for reference. This article describes a pH-sensitive modified polyacrylamide hydrogel that was prepared in two steps. The surface morphology and swelling behavior of the hydrogels were investigated in this paper.

Another example of a polymer exhibiting swelling behavior at different pH values is described in an article titled “A pH-sensitive Modified Polyacrylamide Hydrogel”, which is incorporated herein for reference. The paper was published in Chinese Chemical Letters Vol. 17, No. 3, pp 399-402, 2006. The article shows that the equilibrium swelling ratio of three dried gels did not change in a pH range of 1-7.0; however, at a pH value above 7.0, the equilibrium swelling ratio (Qeq) increased dramatically. This phenomenon may be attributed to the existence of —COOH groups on the polymer side chains.

The materials used in the abovementioned two examples could be used for implementing the present invention; for example the material used in the first example could be used for monitoring whether the pH of a solution exceeds 11 and the material used in the second example could be used for monitoring whether the pH of a solution exceeds 7.

By controlling the polymerization process, the polymer for use in the present invention can be designed such that it substantially does not change its physical state unless a threshold pH value is exceeded. How such a pH sensitive polymer is made can be found in the prior art, e.g. in the abovementioned two examples, and will not be described in detail in the present invention.

For illustration purposes, the devices, systems and methods according to the present invention are described in greater detail herein with reference to exemplary embodiments. However, the disclosed devices, systems and methods have wide ranging applicability, as will be readily apparent to persons skilled in the art.

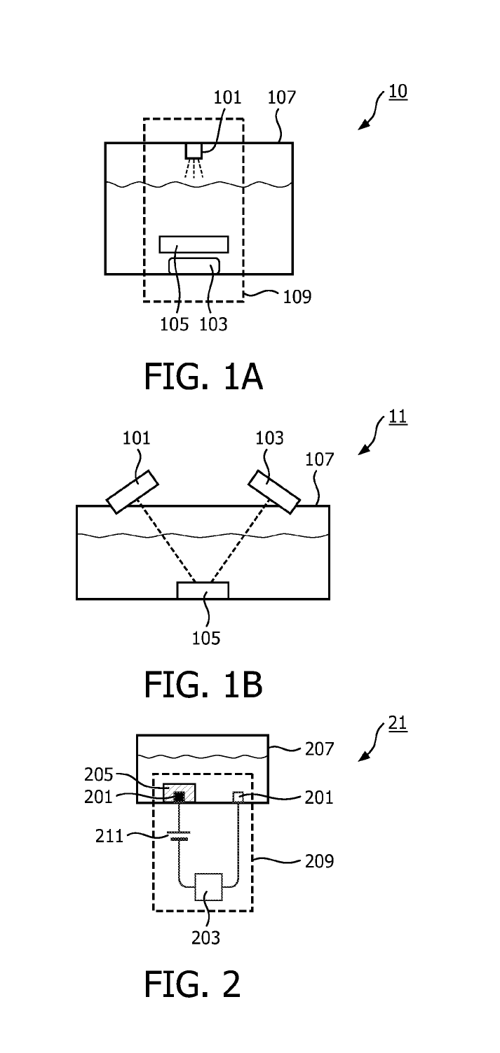

FIG. 1 to FIG. 3 show exemplary embodiments of the pH monitoring device for monitoring the pH of the solution. The pH monitoring device provided comprises a chamber for containing a solution; a polymer being immersed in the solution, wherein the physical state of the polymer is changeable in dependence on whether the pH of the solution exceeds a threshold value; and a detector for detecting the change of the physical state of the polymer. In the context of the present invention, the chamber could be a container containing a solution sample, the chamber could also be a pipe through which the solution flows or any other suitable mechanism.

In FIG. 1A, a pH monitoring device 10 is provided in which a polymer 105 is positioned on the bottom of the chamber 107. The polymer will be dramatically dissolved by the solution when the pH of the solution exceeds (reaches) a threshold value. The detector 109 comprises a light source 101 for emitting a light beam and an optical sensor 103 for detecting the light beam. The polymer is positioned between the light source and the light beam such that the light beam is blocked by the polymer, and the light source and the optical sensor are positioned such that the light beam can be detected by the optical sensor when the polymer is dissolved. The light source and the optical sensor could use an optical coupling device that emits an infrared signal. As a result, when the optical sensor detects the light beam, it indicates that the change of the physical state of the polymer has been detected, i.e. the polymer is dissolved, and this indication means the pH value of the solution exceeds a threshold value.

Alternatively, the pH sensitive polymer can be caused to swell dramatically by the solution when the pH of the solution exceeds a threshold value. In this example, the polymer, the light source and the optical sensor are positioned such that the light beam can be detected by the optical sensor before the polymer has swollen and cannot be detected when the polymer is swollen. For example, the polymer 105 can be made smaller than the optical sensor 103 and does not fully cover the optical sensor and therefore the light beam can be detected by the optical sensor. After the polymer has swollen, it fully covers the optical sensor, thereby blocking the light beam. As a result, when the optical sensor cannot detect the light beam, it indicates that the change of the physical state of the polymer has been detected, i.e. the polymer has swollen.

In FIG. 1A, the light source 101 is positioned at the top of the chamber and the optical sensor is positioned at the bottom of the chamber. Alternatively, the light source and the detector are on the same side, but arranged at an angle with one another. As shown in FIG. 1B, another example device 11 is provided, wherein the light source 101 and the optical sensor 103 are both positioned at the top of the chamber, and at the bottom of the polymer there is a mirror-like surface that can reflect the light source, while the polymer can't. The bottom of the chamber 107 is a mirror-like surface and is covered with a polymer. When the polymer is dissolved, the light beam is detected by the optical sensor after being reflected by the bottom surface of the chamber. Similarly, the light source 101 and the optical sensor 103 can also be positioned both at the bottom of the chamber. In this way, the change of the physical state of the polymer is detected.

FIG. 2 shows another embodiment of a pH monitoring device 21 for monitoring the pH of a solution. The polymer will be dramatically dissolved by the solution when the pH of the solution exceeds a threshold value. In FIG. 2, the detector 209 comprises two electrodes 201 which are insulated by the polymer 205. The insulation can be implemented by for example coating the polymer on the surface of at least one of the two electrodes, because the polymer is non-conductive. The two electrodes are exposed to the solution in the chamber 207. The detector 209 further comprises a power source 211 connected with the two electrodes and an electrical sensor for detecting whether the two electrodes are electrically connected or not. The electrical sensor could be for example an ampere meter, a voltage meter or an ohmmeter. When the polymer is dissolved, the two electrodes can be electrically connected by the solution because the solution is conductive. As a result, the fact that the electrical sensor detects the change of the voltage or current or resistance indicates that the polymer is dissolved, i.e. the physical state of the polymer has changed.

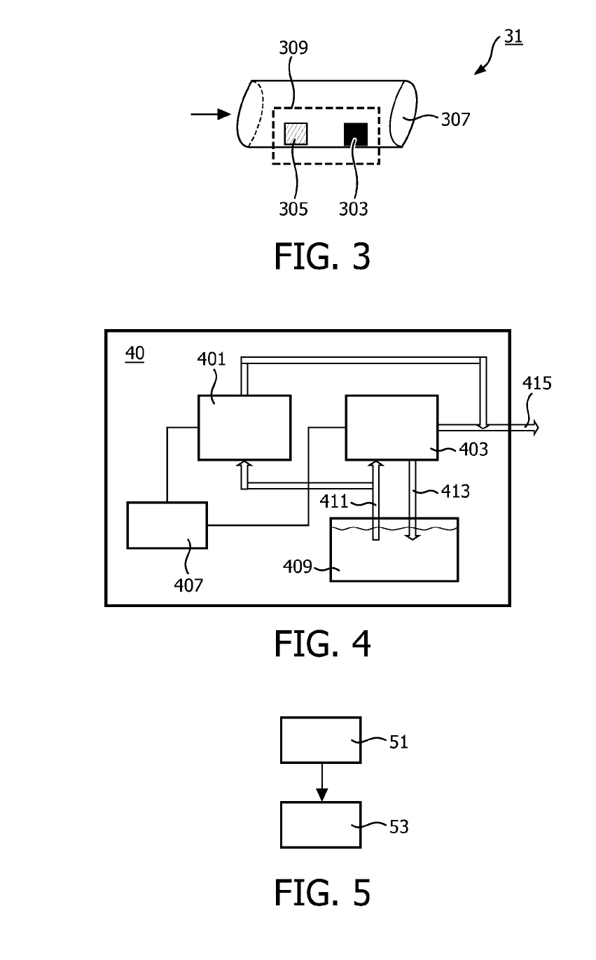

FIG. 3 shows another embodiment of a pH monitoring device 31. In this example, chamber 307 is a pipe through which the solution could flow. If the polymer is dissolvable when the pH of the solution exceeds a threshold value, the polymer 305 could be positioned in the pipe to block the flow. A detector 309 comprises a flow sensor 303 for detecting the flow rate of the solution. As a result, the fact that the flow rate of the solution is greatly increased indicates that the polymer is dissolved.

Alternatively, if the polymer can be caused to swell when the pH of the solution exceeds a threshold value, the fact that the flow rate of the solution is greatly decreased indicates that the polymer has swollen, i.e. the physical state of the polymer changes.

With the indication of the change of the physical state of the polymer, the pH sensor device can detect that the pH value of the solution reaches a threshold value.

This pH monitoring device could be used in various products. FIG. 4 shows an example of a device 40 for processing water. The device 40 comprises a basin 409 originally containing an amount of tap water and an electrolysis unit 403 for electrolyzing the tap water to obtain alkaline water and acid water. The generated alkaline water is sent back to the basin and the generated acid water is sent to other places via pipe 415. As a result, the alkalinity of the water in the basin is continuously increased. The device 40 comprises a pH monitoring device 401 as described above. In this example, the pH monitoring device 401 is used for monitoring the pH value of the alkaline water in the basin. The generated alkaline water or the acid water corresponds to the above mentioned solution. In this example, the monitoring device could also be used for monitoring the acidity of the acid water.

As shown in FIG. 4, the water from the basin is supplied to the pH monitoring device. It will monitor the pH value of the water in the basin. The polymer is designed such that when the pH value of the alkaline water exceeds a threshold value, e.g. 11, the physical state of the polymer will change substantially. The device 40 also comprises a controller 407 to stop electrolyzing the water when the change of the physical state of the polymer has been detected. When the pH value is below the threshold value, the electrolysis module will continue to work. When the pH monitoring device indicates that the pH threshold value is reached, the electrolyzing of the water will be stopped by the controller 407. The controller for example comprises a switch. When the pH monitoring device 401 has detected that the pH value of the alkaline water exceeds the threshold value, this device will trigger a controller signal to open the switch so as to stop the operation of electrolysis unit 403.

In such a way, the electrolyzing process can be controlled, and the alkaline water will not exceed a predefined value.

The present invention further provides a system for cleaning food. The system comprises the device 40 for processing water so as to generate alkaline water with a certain degree of alkalinity and a device for cleaning food using the generated alkaline water. The alkaline water in the basin could also directly be used by the user for washing food by hand. In this hand-washing model, pH monitoring is very important for protecting the user's skin from being damaged by the high alkalinity water.

According to another aspect of the invention, a method of monitoring the pH of a solution is provided. FIG. 5 shows a flow chart for monitoring the pH of a solution according to an embodiment of the invention. The method comprises a step 51 of immersing a polymer in the solution, wherein the physical state of the polymer is changeable in dependence on whether the pH of the solution exceeds a threshold value. In step 53, a detector detects the change of the physical state of the polymer. The change of the physical state corresponds to the polymer being substantially swollen or the polymer being substantially dissolved.

When the detector comprises a light source for emitting a light beam, and the polymer is positioned between the light source and the light beam, step 53 of detecting the change of the physical state comprises a step of detecting the light beam by an optical sensor. As mentioned above, when the polymer can be dissolved by the solution, the polymer will be positioned so as to block the light beam, as a result of which the optical sensor cannot detect the light beam; and after the polymer is dissolved, the light beam can be detected by the optical sensor. Alternatively, when the polymer can be caused to swell by the solution, the polymer will be positioned so as not to block the light beam, and after the polymer has swollen, the light beam cannot be detected by the optical sensor.

When the detector comprises two electrodes insulated by the polymer, and the two electrodes can be electrically connected by the solution when the polymer is dissolved; and a power source connected with the two electrodes, step 53 of detecting the change of the physical state comprises a step of detecting whether the two electrodes are electrically connected or not by an electrical sensor.

When the polymer is positioned in the chamber such that the flow of the solution is blocked when the polymer is swollen, or the polymer is positioned in the chamber such that the flow of the solution is blocked by the polymer and the flow of the solution can be detected when the polymer is dissolved, the step 53 of detecting the change of the physical state comprises a step of detecting the flow rate of the solution.

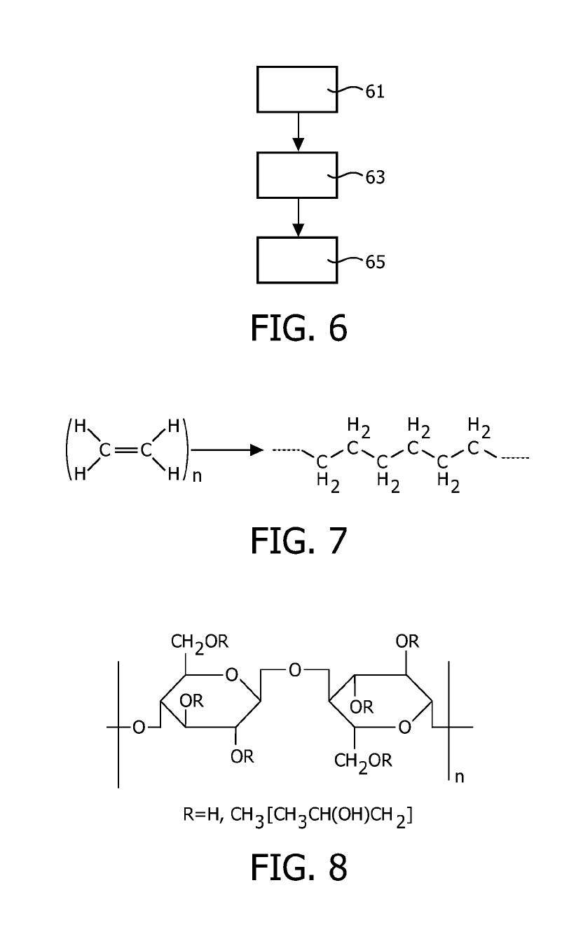

FIG. 6 shows a flow chart of processing water according to an embodiment of the invention. As shown in FIG. 6, in step 61, an electrolysis unit is used for electrolyzing water to obtain alkaline water and acid water. And in step 63, the pH of alkaline water or acid water is monitored according to above mentioned step 51 and step 53. And in step 65 the electrolyzing of water is stopped when the monitoring step 63 indicates that the pH of the alkaline water reaches the threshold value, i.e. the change of the physical state of the polymer has been detected.

The present invention further provides a method of cleaning food. The method comprises a step of processing water according to the method as described above so as to obtain alkaline water and acid water; and a step of washing food by using the alkaline water.

There are numerous ways of implementing functions by means of items of hardware or software, or a combination of hardware and software. In this respect, the drawings are also very illustrative, each representing only one possible embodiment of the invention. For example, the above-mentioned controller 407, the detector 109, 209, 309 can be implemented by one or a plurality of memories stored with different instruction codes, i.e. one or more microprocessors, a plurality of printed circuit boards and some hardware.

It should be noted that the above described embodiments are given for describing rather than limiting the invention, and it is to be understood that modifications and variations may be resorted to without departing from the spirit and scope of the invention as those skilled in the art will readily understand. Such modifications and variations are considered to be within the scope of the invention and the appended claims. The protective scope of the invention is defined by the accompanying claims. In addition, the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A pH monitoring device comprising:
a chamber for containing a solution;
a polymer being immersed in the solution, wherein the dimension of the polymer is changeable in dependence on whether the pH of the solution exceeds a threshold value;
a detector for detecting the change of the dimension of the polymer.

2. The pH monitoring device according to claim 1, wherein the change of the dimension of the polymer corresponds to the polymer being dissolved by the solution, said detector comprising:
a light source (101) for emitting a light beam;
an optical sensor (103) for detecting the light beam;
wherein the polymer is positioned between the light source and the light beam such that the light beam is blocked by the polymer and the light beam can be detected by the optical sensor when the polymer is dissolved.

3. The pH monitoring device according to claim 1, wherein the change of the dimension of the polymer corresponds to the polymer being caused to swell by the solution, said detector comprising:
a light source (101) for emitting a light beam;
an optical sensor (103) for detecting the light beam;
wherein the polymer is positioned between the light source and the light beam such that before the polymer is caused to swell, the light beam is not blocked and when the polymer is swollen, the light beam is blocked by the swollen polymer.

4. (canceled)

5. The pH monitoring device according to claim 1, wherein the change of the dimension of the polymer corresponds to the polymer being dissolved by the solution, and the polymer is positioned in the chamber such that the flow of the solution is blocked by the polymer and the flow of the solution can be detected when the polymer is dissolved, said detector comprising:
a flow sensor for detecting the flow rate of the solution.

6. The pH monitoring device according to claim 1, wherein the change of the dimension of the polymer corresponds to the polymer being caused to swell by the solution, and the polymer is positioned in the chamber such that the flow of the solution is blocked when the polymer is swollen, said detector comprising:
a flow sensor for detecting the flow rate of the solution.

7. A device for processing water, comprising:
a pH monitoring device according to claim 1;
an electrolysis unit for electrolyzing water to obtain alkaline water and acid water, wherein the alkaline water or the acid water corresponds to the solution;
a controller for stopping the electrolyzing of water when the change of the dimension of the polymer has been detected.

8. A system for cleaning food, the system comprising:
a device for processing water;
a device for cleaning food using the alkaline water.

9. A method of monitoring the pH of a solution, comprising the steps of:
immersing a polymer in the solution, wherein the dimension of the polymer is changeable in dependence on whether the pH of the solution exceeds a threshold value;
detecting the change of the dimension of the polymer by a detector.

10. The method according to claim 8, wherein the change of the dimension of the polymer corresponds to any one of the following:
the polymer being swollen;
the polymer being dissolved.

11. The method according to claim 8, wherein said detector comprises a light source for emitting a light beam, and the polymer is positioned between the light source and the light beam; said step of detecting the change of the physical state comprising a step of detecting the light beam by an optical sensor.

12. (canceled)

13. The method according to 8, wherein the polymer is positioned in the chamber such that the flow of the solution is blocked when the polymer is swollen, or the polymer is positioned in the chamber such that the flow of the solution is blocked by the polymer and the flow of the solution can be detected when the polymer is dissolved; said step of detecting the change of the dimension comprising a step of detecting the flow rate of the solution.

14. A method of processing water, comprising the steps of:
electrolyzing water to obtain alkaline water and acid water;
monitoring the pH of alkaline water or acid water according to the method as claimed in claim 8;
stopping the step of electrolyzing water when the change of the dimension of the polymer has been detected.

15. A method of cleaning food, comprising the steps of:
processing water according to the method as claimed in claim 14 so as to obtain the alkaline water and the acid water;
washing food by using the alkaline water.
